(19) United States
(12) Patent Application Publication
(10) Pub. No.: US 2005/0046572 A1
(43) Pub. Date: Mar. 3, 2005

(54) Store security tag detector

(76) Inventor: Frank Hader, Brantford (CA)

Correspondence Address: ROBERT F. DELBRIDGE;GOWLING LAFLEUR HENDERSON LLP, 560-120 KING STREET WEST, LCD 1, P.O. BOX 1045, HAMILTON, ON, L8N 4R3, CA

(21) Appl. No.: 10/912,199

(22) Filed: Aug. 6, 2004

Related U.S. Application Data
(60) Provisional application No. 60/493,334, filed on Aug. 8, 2003.

(51) Int. Cl. G08B 13/14

(52) U.S. Cl. 340/572.7

(57) ABSTRACT

A door mountable in a door opening for opening and closing movement about a vertical access is provided with a transmitting and/or receiving antenna of a store security tag detector and is connectable to a detector processor for detecting the passage of a security tag through the door opening.

### RELATED APPLICATION

This application claims priority from U.S. Provisional Patent Application No. 60/493,334 filed Aug. 8, 2003.

### FIELD OF INVENTION

This invention relates to store security tag detectors.

### BACKGROUND OF INVENTION

It is well known that shoplifting from retail stores is a major problem and store owners have to take precautions accordingly. Usually, suitable tags are attached to products in a store and a fixed detector adjacent a store exit detects a tag on a product carried by a shopper attempting to leave the store without paying for the product. Normally of course, the tag will have been previously removed by a sales clerk when the product is paid for.

Depending on the technology used, the detector may comprise a single detector unit having transmitting and receiving antennae and associated circuitry or may comprise a pair of spaced detector units each with a single transmitting or receiving antenna and associated circuitry. A tag passing near the single detector unit or between the pair of detector units will be detected. However, such detector units take up space adjacent the exit and are usually somewhat unsightly. Also, again depending on the technology used, there is a possibility that a tag will not be detected if it is not near the single detector unit or between the pair of detector units for a sufficient time.

It is therefore an object of the invention to provide a store security tag detector which at least substantially overcomes the problems mentioned above.

### SUMMARY OF INVENTION

Many stores have an exit door which is normally closed and has to be opened manually or automatically to allow a customer to exit. According to the present invention, such an exit door is provided with a transmitting and/or receiving antenna of a store security tag detector. Thus, not only is it no longer necessary for one or more detector units to be located adjacent to the door in a space occupying and probably unsightly manner, but a tag on a product being carried out of the store by consumer who has not paid for the product will be near the door-carried antenna for a longer time than may be the case with a separate fixed detector unit or units, therefore increasing the likelihood of the tag being detected.

### BRIEF DESCRIPTION OF THE DRAWINGS

One embodiment of the invention will now be described, by way of example, with reference to the accompanying drawings, of which:

FIG. 1 is a front view of an antenna assembly in accordance with one embodiment of the invention,

FIG. 2 is an exploded perspective view of the antenna assembly,

FIG. 3 is a perspective view of the antenna assembly showing the backing sheet being removed,

FIG. 4 is a perspective view showing the antennae and the cover sheet applied to a door, and with the cover sheet in an initial stage of removal, and

FIG. 5 is a perspective view of the door with the antennae carried thereby and connected to a conventional processor.

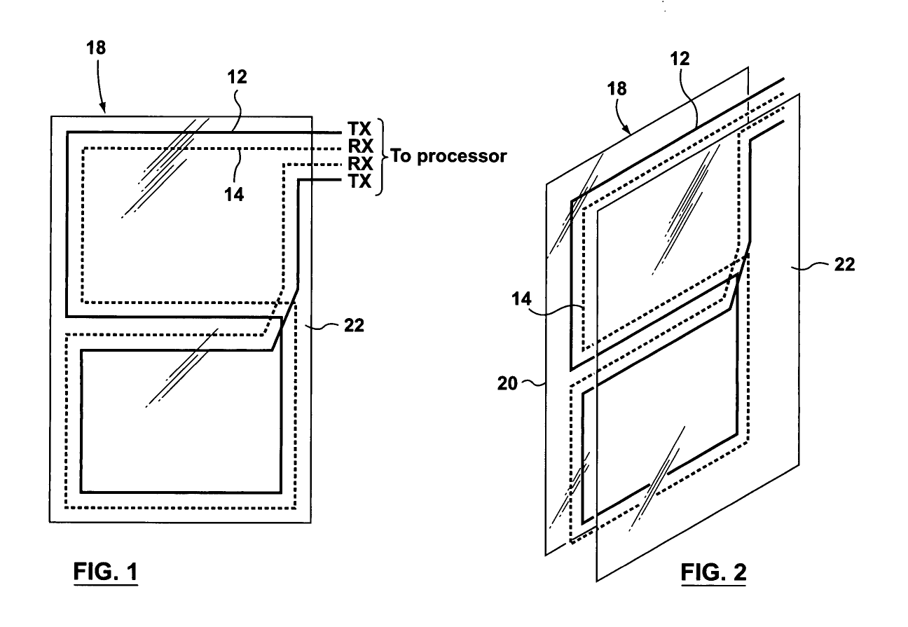

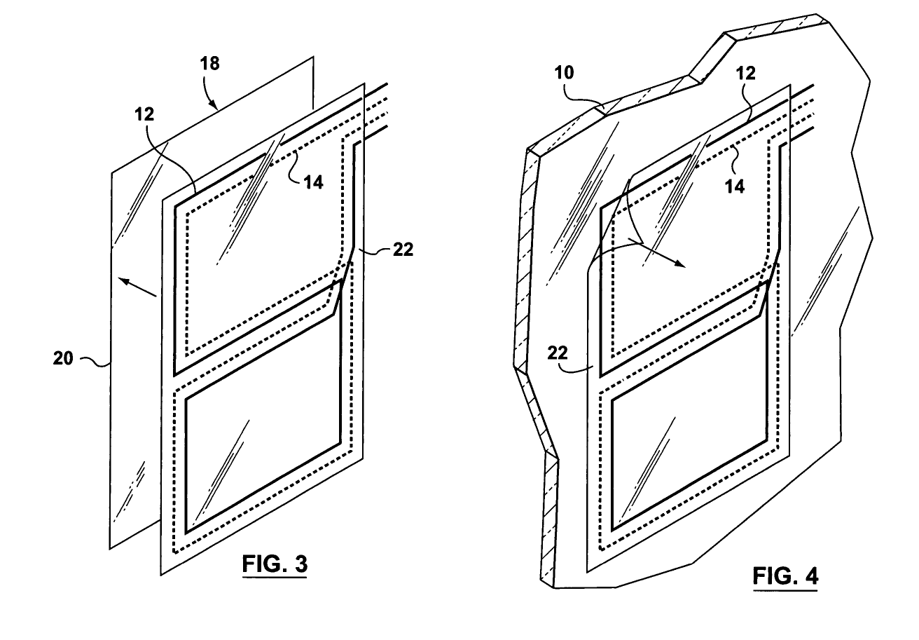

### DESCRIPTION OF PREFERRED EMBODIMENTS

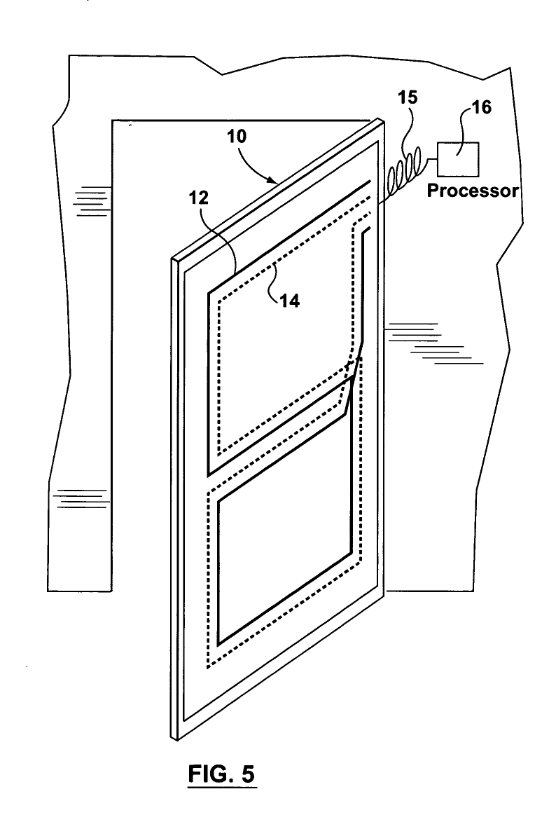

Referring to the drawings, a normally closed glass door 10 (see FIG. 5) in a retail store has a transmitting antenna 12 and a receiving antenna 14 of a tag detector secured thereto in accordance with one embodiment of the invention. The antennae are connected by wiring 15 to a conventional detector processor 16 which may be conveniently adjacent to the door 10.

Also in accordance with the invention, an antenna assembly 18 including the transmitting and receiving antennae 12, 14 (which are in the form of metal strips) is provided to enable the antennae 12, 14 to be retrofitted to the door 10. The assembly 18 has a Mylar backing sheet 20 to which the antennae 12, 14, are removably secured by a suitable adhesive carried by the antennae 12, 14. For protection prior to installation, a Mylar cover sheet 22 is removably secured to the antennae 12, 14 and the backing sheet 20 by a suitable adhesive carried by the cover sheet 22.

To secure the so packaged antennae 12, 14 to a door 10, the backing sheet 20 is removed from the antennae 12, 14 and the cover sheet 22 and the antennae 12, 14 and the cover sheet 22 are applied to the door 10. The cover sheet 22 is pulled away from the door 10 and the antennae 12, 14, leaving the antennae 12, 14 adhesively secured to the door 10. The wiring 15 is then attached to the antennae 12, 14 and the processor 16 in a conventional manner.

The advantages of the invention will now be readily apparent to a person skilled in the art from the foregoing description of preferred embodiments. Other embodiments of the invention will also now be readily apparent, the scope of the invention being described in the appended claims.

1. A door mountable in a door opening for opening and closing movement about a vertical access and provided with a transmitting and/or receiving antenna of a store security tag detector and connectable to a detector processor for detecting the passage of a security tag through the door opening.

2. A door assembly including a wall with a door opening and a door mounted in the opening for opening and closing movement about a vertical access, said door having a transmitting and/or receiving antenna of a store security tag detector mounted thereon and connected to a detector processor for detecting the passage of a security tag through the door opening.

3. A method of providing a door for use in a door assembly as claimed in claim 1 including providing an antenna assembly having a transmitting and receiving antenna of a store security tag detector mounted between adhesive backing and cover sheets, and removing the backing sheet and applying the transmitting and receiving antenna and the cover sheet to the door.

4. A method according to claim 3 including also removing the cover sheet after the transmitting and receiving antenna have been applied to the door.
